(19) United States
(12) Patent Application Publication
(10) Pub. No.: US 2011/0040893 A1
(43) Pub. Date: Feb. 17, 2011

(54) Distributed Internet caching via multiple node caching management

(75) Inventors: Jeyhan Karaoguz, Irvine, CA (US); James D. Bennett, Hroznetin (CZ)

Correspondence Address: GARLICK HARRISON & MARKISON, P.O. BOX 160727, AUSTIN, TX, 78716-0727, US

(73) Assignee: BROADCOM CORPORATION, IRVINE, CA (US)

(21) Appl. No.: 12/696,340

(22) Filed: Jan. 29, 2010

Related U.S. Application Data
(60) Provisional application No. 61/234,232, filed on Aug. 14, 2009.

(51) Int. Cl. G06F 15/173

(52) U.S. Cl. 709/242

(57) ABSTRACT

Distributed Internet caching via multiple node caching management. Caching decisions and management are performed based on information corresponding to more than one caching node device (sometimes referred to as a distributed caching node device, distributed Internet caching node device, and/or DCN) within a communication system. The communication system may be composed of one type or multiple types of communication networks that are communicatively coupled to communicate there between, and they may be composed of any one or combination types of communication links therein [wired, wireless, optical, satellite, etc.]). In some instances, more than one of these DCNs operate cooperatively to make caching decisions and direct management of content to be stored among the more than one DCNs. In an alternative embodiment, a managing DCN is operative to make caching decisions and direct management of content within more than one DCNs of a communication system.

### CROSS REFERENCE TO RELATED PATENTS/PATENT APPLICATIONS

### Provisional Priority Claims

The present U.S. Utility Patent Application claims priority pursuant to 35 U.S.C. §119(e) to the following U.S. Provisional Patent Application which is hereby incorporated herein by reference in its entirety and made part of the present U.S. Utility Patent Application for all purposes:

1. U.S. Provisional Application Ser. No. 61/234,232, entitled “Distributed Internet caching via multiple node caching management,” (Attorney Docket No. BP20017), filed Aug. 14, 2009, pending.

### BACKGROUND OF THE INVENTION

1. Technical Field of the Invention

The invention relates generally to management of stored content within a communication system; and, more particularly, it relates to employing information corresponding to multiple caching node devices to direct and manage caching of content within such a communication system.

2. Description of Related Art

Data communication systems have been under continual development for many years. Certain communication systems are composed of multiple devices implemented throughout and that may be viewed as nodes (or alternatively referred to as routers) of the communication system. For example, within a typical prior art communication system, the router infrastructure caches content (e.g., composed of files, packets, or generally any type of digital information, etc.) on a router by router basis. In other words, each router (or node) makes caching decisions therein based on traffic volume, as monitored and seen only as that particular router, and independently makes a decision to cache or to discard cached files. As may be understood, when a particular router making a decision to cache or to discard content that was previously cached will consequently affect neighboring routers within the communication system.

The prior art means of managing and directing caching of content on a router by router basis is ineffectual to meet the needs of high volume content communication systems (e.g., the Internet) in which many users oftentimes seek to retrieve the same content. For example, many users of the Internet will oftentimes download the very same content either simultaneously or within a particular period of time. When each of routers within the Internet make caching decisions of content on a router by router basis, then across the Internet, there is inherently little or no intelligence as to where content is cached.

### BRIEF SUMMARY OF THE INVENTION

The present invention is directed to apparatus and methods of operation that are further described in the following Brief Description of the Several Views of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 is a diagram illustrating an embodiment of a communication system includes a number of caching node devices (depicted as DCNs).

FIG. 2 is a diagram illustrating an embodiment of a caching node device (DCN).

FIG. 3 is a diagram illustrating an embodiment of multiple DCN operating in accordance with port specific caching.

FIG. 4 is a diagram illustrating an embodiment of a DCN operating based on information (e.g., cache reports) received from one or more other DCNs.

FIG. 5 is a diagram illustrating an embodiment of more than one DCN operating in cooperation with one another in accordance with selective content caching.

FIG. 6 is a diagram illustrating an embodiment of a DCN that is operative to perform independent and distributed caching operations.

FIG. 7 is a diagram illustrating an embodiment of a number of DCNs partitioned into a number of clusters that perform distributed caching operations therein.

FIG. 8 is a diagram illustrating an embodiment of a number of DCNs whose operation is managed by a managing DCN.

FIG. 9 is a diagram illustrating an embodiment of a number of DCNs, partitioned into a number of clusters, such that the operation of each cluster is managed by a respective, managing DCN.

FIG. 10A is a diagram illustrating an embodiment of a method for performing cache management based on information corresponding to more than one DCN within a communication system.

FIG. 10B is a diagram illustrating an embodiment of an alternative method for performing cache management based on information corresponding to more than one DCN within a communication system.

FIG. 11A is a diagram illustrating an embodiment of a method for performing cache management across multiple DCNs within a communication system.

FIG. 11B is a diagram illustrating an embodiment of a method for performing selective content caching across multiple DCNs within a communication system.

FIG. 12A is a diagram illustrating an embodiment of a method for selectively performing independent and distributed caching operations.

FIG. 12B is a diagram illustrating an embodiment of a method for operating a number of DCNs, partitioned into a number of clusters, to perform caching operations therein.

### DETAILED DESCRIPTION OF THE INVENTION

A novel and effective means of managing and directing the caching of content within a communication system is presented herein. Various aspects of the invention presented herein may be applied across any of a variety of communication systems that has more than one caching node device. One such types of communication system in which such principles may be implemented is the Internet. The Internet may be viewed as being composed of multiple communication networks that are communicatively coupled together, and various communication links within the Internet may be implemented using any one or combination types of communication links therein [wired, wireless, optical, satellite, etc.].

Various communication devices within a communication by which content is stored, cached, and communicated from one location to another may be viewed as being routers or nodes. Generally speaking, such router or node communication devices within a communication system may be referred to as a caching node device (sometimes alternatively referred to as a distributed caching node device, distributed Internet caching node device, and/or simply DCN).

Instead of a single DCN making caching and discard decisions with respect to content independently, such decisions are managed based on information corresponding to one or more additional DCNs. For example, instead of a particular DCN making its own caching decisions without any cooperation or interaction with other DCNs of the communication network, a DCN makes its own caching decisions based on traffic flow and caching decisions made by at least one additional DCN. In some embodiments, one DCN makes decisions based on information received from other DCNs (e.g., via cache reports provided from the other DCNs) of their respective caching and discard decisions. In other embodiments, two or more DCNs operate cooperatively via bi-directional communication there between. In even other embodiments, a central or managing communication device (e.g., which may be a master or managing DCN) governs and directs the caching performed by the various DCNs.

For example, the management of caching content within various DCNs is to effectuate the control of such caching or discard decisions, or alternatively merely to report (or in addition to) such decisions so that neighboring DCNs may be made aware of what caching or discard may be performed by other DCNs so that the various DCNs are therefore able to make better decisions about their respective caching and discard approached. Such management may be distributed amongst neighboring nodes (e.g., other DCNs as mentioned above) or handled by a central or managing communication device node (e.g., a server, an appointed router, or a master DCN).

If a DCN reports its caching information (e.g., which may generally be referred to as a cache report) upstream (e.g., toward the cache source) and downstream (e.g., toward the requesting client device—that requests the content), pathway DCNs may the redirect requests in any direction, to any one or more appropriate or selected DCNs, to reach the closest DCN better suited to perform the cache or the original source and to make a more educated decision as to whether that DCN should cache itself. It is noted that, in many cases, a DCN implemented in an upstream pathway may actually vector the packet request away from the source to be cached in a DCN that is closer than the source.

When a particular DCN decides to discard content (i.e., not to cache it therein), then a cache report could indicate the deletion of the content and that cache report could be sent to one or more other DCNs. In addition, a DCN may make a decision to cache content for only a particular period of time (e.g., a predetermined period of time or an adaptively determined period of time [e.g., modified based on traffic flow, operating conditions, etc.]). Such indication in a cache report may be referred to as a “cache life”, and it would indicate in advance when content that is cached within a DCN will be dropped/discarded by that DCN.

Also, the communication of cache reports between various DCNs (e.g., indicating neighboring cache sharing and cache information sharing) might operate alternatively as an overlay to the current “local caching” approach and become active only in reaction to or based on repetition packet flow meeting some threshold (e.g., categorized as high, very high, etc.). A neighboring DCN receiving a cache report might thereafter choose not to cache content or also to cache the content depending on its respective local resources (availability of memory, use of operating resources, etc.) and local flow repetition. If such a neighboring DCN chooses also to perform local caching, that DCN delivers the appropriate information to the original DCN from which the content came so that the original DCN, in turn, may make a decision to stop or continue caching particular content or content altogether.

As mentioned above, such caching decisions may be handled by a central or managing communication device node (e.g., a server, an appointed router, or a master DCN) or even a central cluster of communication device nodes (e.g., cluster of server, cluster of appointed router, or a cluster of master DCNs). Such centralized sharing with a central DCNs or central cluster of DCNs (which may or may not be actual routers and be typical servers) may receive at least high repetition volume flow information from the underlying DCN infrastructure of the communication system. Individual DCNs in the infrastructure may operate in a variety of modes, for example:

a) DCNs may operate independent (localized) caching decisions only and only reports to the central node/cluster;

b) DCNs may perform in accordance with mode “a)” for low volume repeat traffic and mode “c)” (below) for high volume repetition; and

c) DCNs report repetition information to and awaits instructions from a central or managing DCN for use by the central or managing DCN take appropriate actions (e.g., do nothing, cache, or redirect packet requests to local neighbor DCNs (address encapsulation).

A central or managing DCN can evaluate all routing traffic within the communication system, or the central or managing DCN may alternatively be implemented for use in handling primarily or only higher repetition traffic routing pathways so as to minimize the overall coordination burden on the router network infrastructure. Also, upon coming “online”, each server reports its capability and port pathway information to central so that central can make more reasonable participation decisions. While in service, each router reports overall port traffic flow info in real time to the central even for non-repeat traffic so that central may load balance the infrastructure by moving caches to less used port pathway routers.

Also, caching may be managed and controlled amongst various DCNs in accordance with a port specific caching approach. For example, conventional communication devices (e.g., routers) within a communication system may each be implemented to have a centralized cache to service all ports thereof. Because the caching approach is centralized, access delays may arise where cache storage access is requested by multiple ports at the same time. This architecture may typically be sufficient for conventional routers because each request for repeated content (e.g., as made by an end point client from a server) will be locally checked against the cache of that particular router before sending the request upstream. If the content is found in cache of that particular router, then the router can source the information, instead of the server, via other routers and the current server's upstream port.

However, if the network caching infrastructure of a communication system is modified in accordance with the various approaches described above (such as distributed caching management among/in cooperation with multiple DCNs or using a central or managing DCN), then cache collisions may increase to a point of unacceptability with higher volume repetition traffic that not only supports the current router but also supports neighboring routers as well.

This may be addressed in accordance with such a port specific caching approach. That is to say, instead of (or in addition to) employing a single/common cache memory within a particular DCN, the DCN may include more than one cache memory such that each respective cache memory is allocated specifically to a respective port within the DCN (e.g., one cache memory for each respective port, or a dedicated, respective group/subset of memories for each respective port).

Within a DCN, centralized caching therein may also be used with a management module or circuitry responding to either or both the central or managing DCN/cluster of managing DCNs and local port cache usage information to determine where and when to migrate or discard central and port specific caches.

For example, if a DCN router offers or provides a shared cache (e.g., a cache for at least one neighboring DCN (or near neighboring DCNs)), then that cache will oftentimes be responsive to a single port. In such situations, the management module or circuitry may (independently or under direction or advice from a central DCN) either initiate caching on that port's cache or migrate the cache from the router's main (central) cache to the port's cache (and may be performed with or without retaining a copy of the content that is/was cached). In other words, by increasing cache usage within a router to support other network routers within a corn system, port associated caching may provided significantly improved performance.

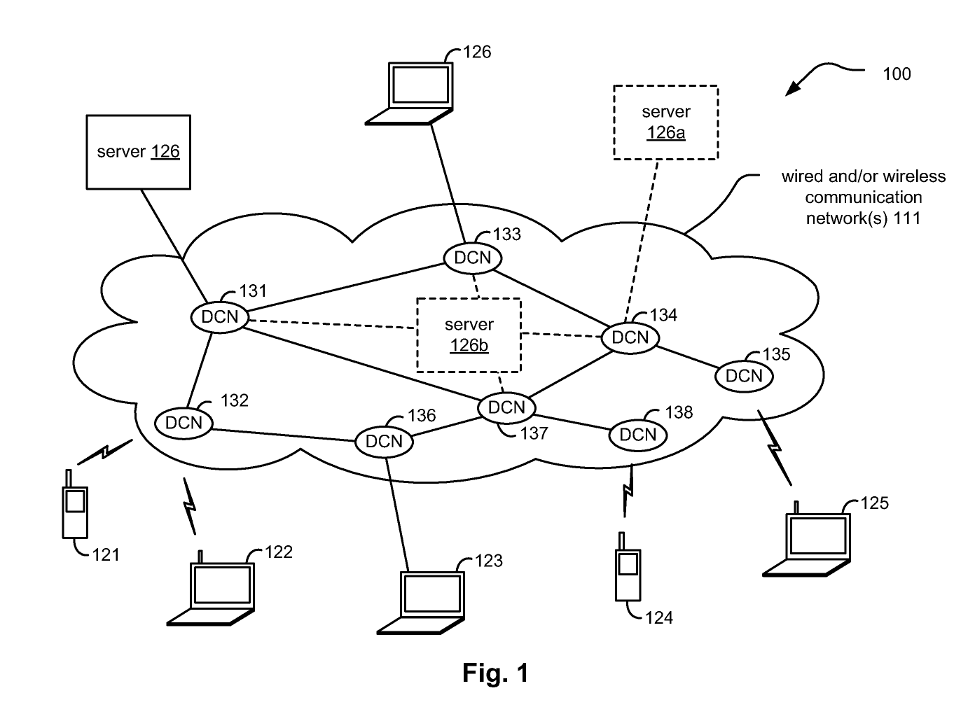

FIG. 1 is a diagram illustrating an embodiment 100 of a communication system includes a number of caching node devices (depicted as DCNs). A general communication system is composed of one or more wired and/or wireless communication networks (shown by reference numeral 111) includes a number DCNs (shown by reference numerals 131, 132, 133, 134, 135, 136, 137, and 138). The communication network(s) 111 may also include more DCNs without departing from the scope and spirit of the invention.

In some embodiments, a server 126 may be implemented to be coupled (or to be communicatively coupled) to one of the DCNs (shown as being connected or communicatively coupled to DCN 131). In other embodiments, a server 126a may be communicatively coupled to DCN 134, or a server 126b may be coupled to more than one DCNs (e.g., shown as optionally being communicatively coupled to DCNs 131, 133, 134, and 137).

One or more communication devices (shown as wireless communication device 121 [such as a cellular or mobile phone, a personal digital assistant, etc.], a laptop computer with wireless communication capability 122, a laptop computer with wired communication capability 123, wireless communication device 124, a laptop computer with wireless communication capability 125, a laptop computer with wired communication capability 126, etc.) are operative to communicate with the communication network(s) 111.

This embodiment 100 shows one example of the general context in which distributed content caching may be effectuated via multiple nodes (e.g., using multiple DCNs). In some embodiments, the various DCNs may selectively change their operation to perform caching either independently (i.e., without cooperation with other DCNs) or cooperatively (i.e., with cooperation with other DCNs).

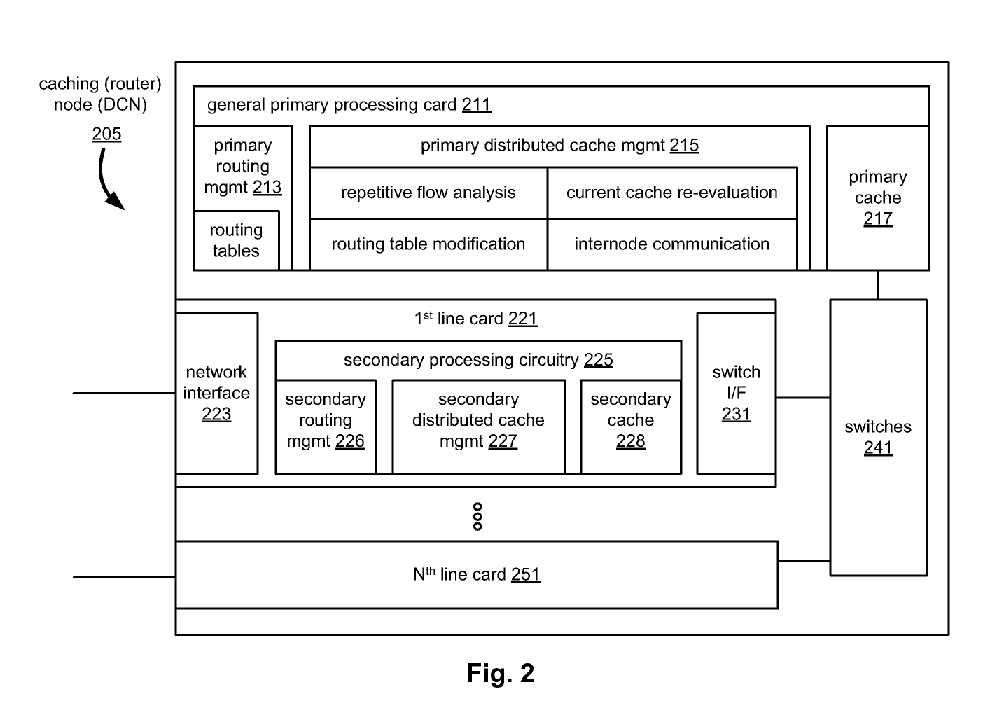

FIG. 2 is a diagram illustrating an embodiment of a caching node device (DCN) 205. The DCN 205 includes a general primary processing card 211 that includes circuitry to effectuate certain functions including primary routing management 213 (including keeping/updating routing tables, etc.), primary distributed cache management 215 (including repetitive flow analysis, current cache re-evaluation, routing table modification, internode communication, etc.), and a primary cache 217.

A number of switches 241 couple the general primary processing card 211 to a number of line cards, shown as 221 up to 251. Each respective line card, as shown with reference to the first line card 221, includes a switch interface 231, a secondary processing circuitry 225 (that includes a secondary routing management circuitry 226, a secondary distributed cache management circuitry 227, a secondary cache circuitry 228), and a network interface 223.

The DCN 205 is operative to employ the respective line cards 221-251 to communicate with various other communication devices (including other DCNs) within a communication system. As can be seen, every respective line card may be selectively coupled to the general primary processing card 211 via the switches 241. Also, the DCN 205 itself includes a primary cache 217, and every respective line card includes a respective secondary cache 228. Therefore, caching of content may be performed even within a singular DCN 205 amongst multiple caches (e.g., in the primary cache 217 and in the respective secondary caches 228).

In addition, routing management is likewise distributed amongst various portions of the DCN 205 (e.g., amongst the primary routing management 213 of the DCNs and amongst the various respective secondary routing management circuitries 226 of the line cards 221-251), and distributed cache management is also likewise distributed amongst various portions of the DCN 205 (e.g., amongst the primary distributed cache management 215 of the DCNs and amongst the various respective secondary distributed cache management circuitries 227 of the line cards 221-251).

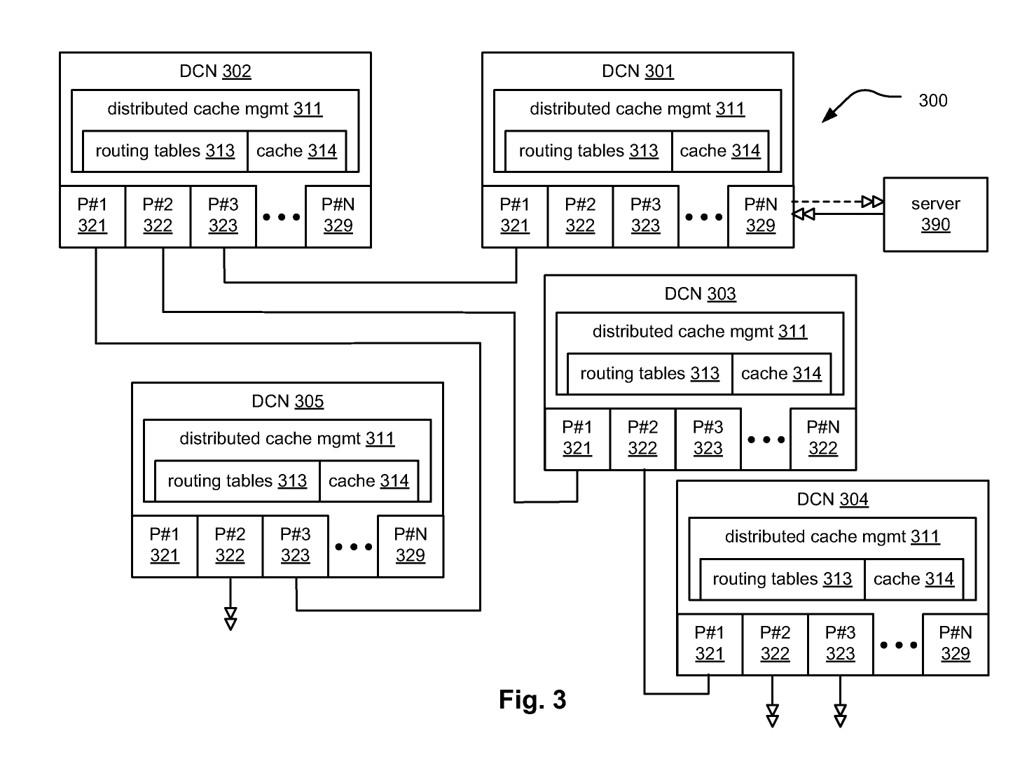

FIG. 3 is a diagram illustrating an embodiment 300 of multiple DCN operating in accordance with port specific caching. This embodiment 300 shows multiple DCNs 301, 302, 303, 304, and 305. Each respective DCN includes a distributed cache management circuitry 311 (that includes capability to keep/address/update routing tables 313 and operate a cache 314). This embodiment 300 shows the DCN 301 being communicatively coupled to server 390. The various DCNs 301-304 are respectively coupled via respective ports (shown as P#1 321, P#2 322, P#3 323, and up to P#N 329).

As described above, caching may be managed and controlled amongst various DCNs in accordance with a port specific caching approach. This architecture that is operative to perform port specific caching allows the use of specific, dedicated ports to communicate selectively with ports of other DCNs. This allows the use of individual respective memories, corresponding to specific ports, to effectuate caching of content amongst various DCNs within a communication system.

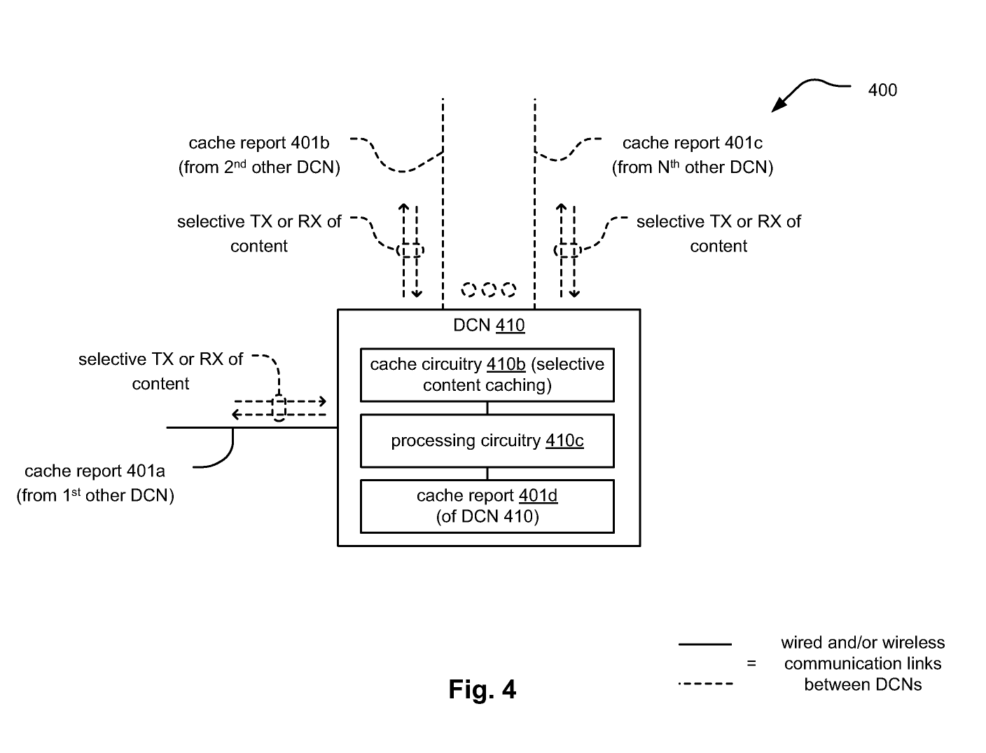

FIG. 4 is a diagram illustrating an embodiment 400 of a DCN operating based on information (e.g., cache reports) received from one or more other DCNs. A DCN 410 includes cache circuitry 410b (that is operative to perform selective content caching) and processing circuitry 410c. The DCN 410 is operative to receive a cache report 401a transmitted from at least one other DCN. The cache report 401a is processed by the DCN 410 to determine what caching operations to perform and to generate a cache report 401d that corresponds to the DCN 410 itself.

The DCN 410 is operative to generate the cache report 401d corresponding to the DCN 410, and the DCN 410 is operative to receive the cache report 401a corresponding to a second caching node device. Based on the cache report 401a (and also sometimes based on the cache report 401d that corresponds to the DCN 410 itself), the DCN 410 selectively caches content within the DCN 410 (e.g., in the cache circuitry 410b) or transmits the content and the cache report 401d to another DCN. In some embodiments, the DCN 410 modifies the cache report 401d (or generates it in the first place) based on the cache report 401.

Also, in other embodiments, the DCN 410 may also receive more than one cache report (e.g., cache report 401b from a second other DCN, and up to a cache report 401c from an Nth other DCN). More than one or all of these cache reports may be processed and analyzed by the DCN 410 to assist in cache operations.

The information included within a cache report may be varied. The information within the cache report 401a may indicate the cache storing capability of the DCN from which the cache report 401a is transmitted. Similarly, the information within the cache report 401d may indicate the cache storing capability of the DCN 410 itself. A cache report may also indicate cache history corresponding to content that is currently or has been previously cached within the DCN to which the cache report corresponds.

In addition, sometimes a communication device makes one or more requests for particular information to be provided to it. Alternatively, a number of communication devices collectively make requests for the same content to be provided to them. As such, cache report can indicate the identification of one or more additional communication devices (e.g., caching node devices) that provide one or more requests for such content.

Moreover, a particular DCN may transmit a cache report to another DCN selectively based on a particular condition. For example, this may be based on when a particular DCN does in fact does selectively cache content therein. For example, in instances when the DCN does not cache content therein, then the DCN does not need to transmit the cache report to another DCN.

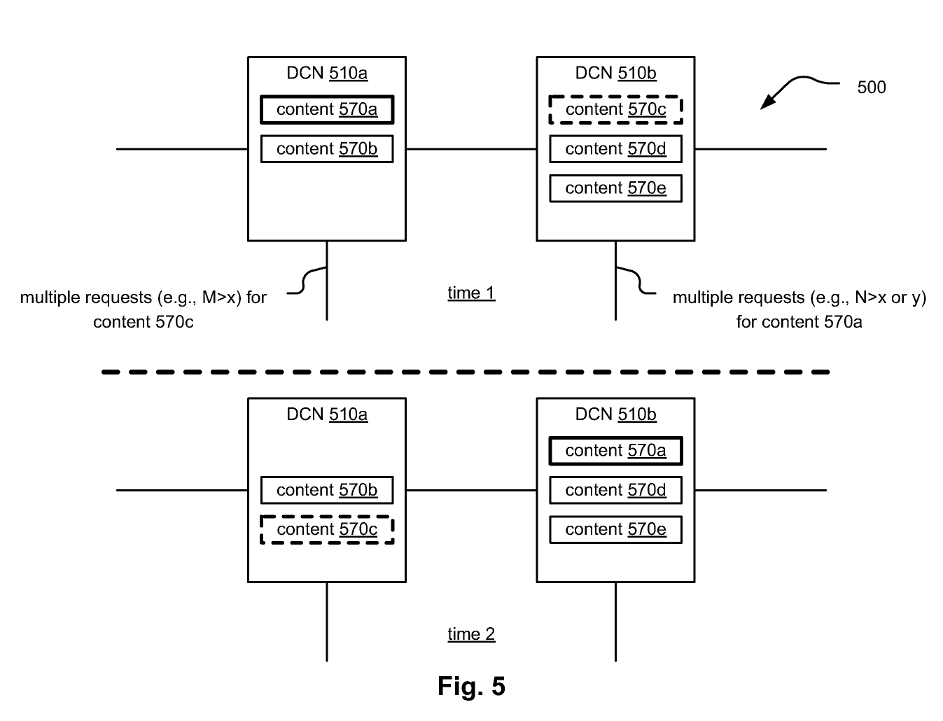

FIG. 5 is a diagram illustrating an embodiment 500 of more than one DCN operating in cooperation with one another in accordance with selective content caching. This embodiment depicts DCNs 510a and 510b, shown at a first time and a second time, respectively. Based upon cache reports generated by and/or exchanged between the DCNs 510a and 510b, content that is cached within each of the DCNs 510a and 510b may be moved from one DCN to the other.

For example, this embodiment 500 shows the DCN 510a including content 570a and 570b. The DCN 510b is shown as including content 570c, 570d, and 570e. Based on cache reports exchanged between the DCNs 510a and 510b, and based on the information indicated therein, content is moved from the DCN 510a to the DCN 510b. For example, there may be an instance where communication devices that are communicatively coupled to the DCN 510b request the content 570a with a sufficiently high number of requests (e.g., predetermined number of requests, number of requests exceeding some adaptively adjusted threshold, etc.). The DCN 510b may be better situated than the DCN 510a to service these requests by the communication devices that desire the content 570a. As such, the DCN 510a transmits the content 570a to the DCN 510b (as shown by time 2).

Analogously, there may be an instance where communication devices that are communicatively coupled to the DCN 510a request the content 570c with a sufficiently high number of requests (e.g., predetermined number of requests, number of requests exceeding some adaptively adjusted threshold, etc.). The DCN 510a may be better situated than the DCN 510b to service these requests by the communication devices that desire the content 570c. As such, the DCN 510b transmits the content 570c to the DCN 510a (as shown by time 2).

As can be seen, the DCNs 510a and 510b operate cooperatively to cache content there among (i.e., among each of the DCNs 510a and 510b or even amongst other DCNs as well).

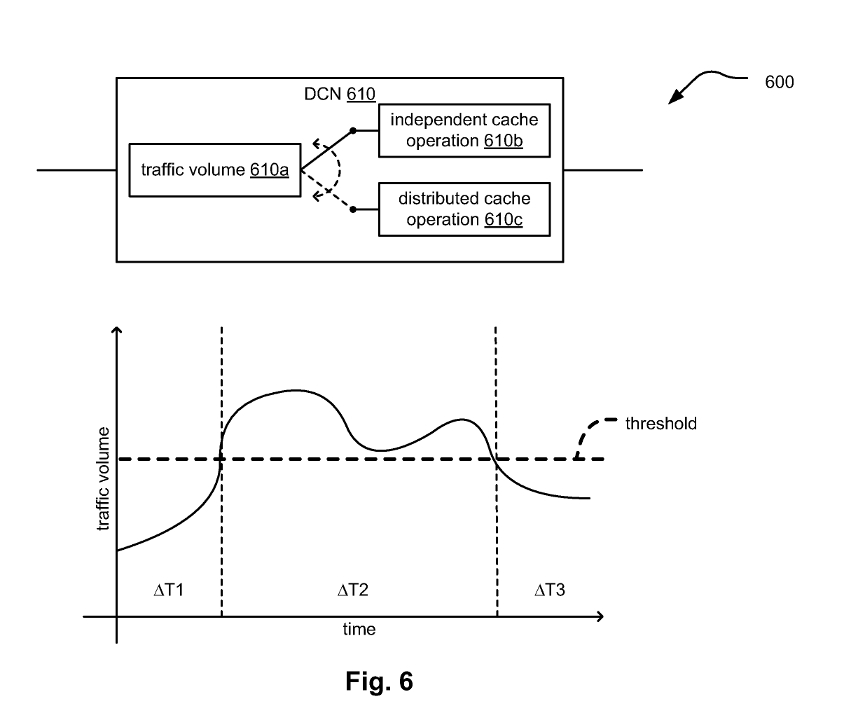

FIG. 6 is a diagram illustrating an embodiment 600 of a DCN that is operative to perform independent and distributed caching operations. This embodiment shows DCN 610 that includes a means to ascertain (or monitor) traffic volume 610a and selectively to change the mode of operation of the DCN 610 from performing either independent cache operation 610b or distributed cache operation 610c. For example, one or more of the various DCNs of a communication system may selectively change their operation to perform caching either independently (i.e., without cooperation with other DCNs) or cooperatively (i.e., with cooperation with other DCNs).

The lower portion of FIG. 6 shows how traffic volume may vary as a function of time. There are three separate shown time increments, and the traffic volume is above or below the threshold at different of the time increments. This threshold may be a fixed/predetermined threshold, or the threshold may be adjusted based on any of a number of considerations. For example, the threshold may be adaptively adjusted (up or down) in real time based on any number of considerations including one or more DCNs' processing resource availability, noise on the communication system (or specific communication links), etc.

The operation of the DCN 610 may be switched between each of these modes of operation (e.g., independent cache operation 610b or distributed cache operation 610c) may be made in real time. In some instances, the DCN 610 operates cooperatively with other DCNs in accordance with distributed cache operation 610c, and it makes caching decisions individually without respect of other DCNs in accordance with independent cache operation 610b.

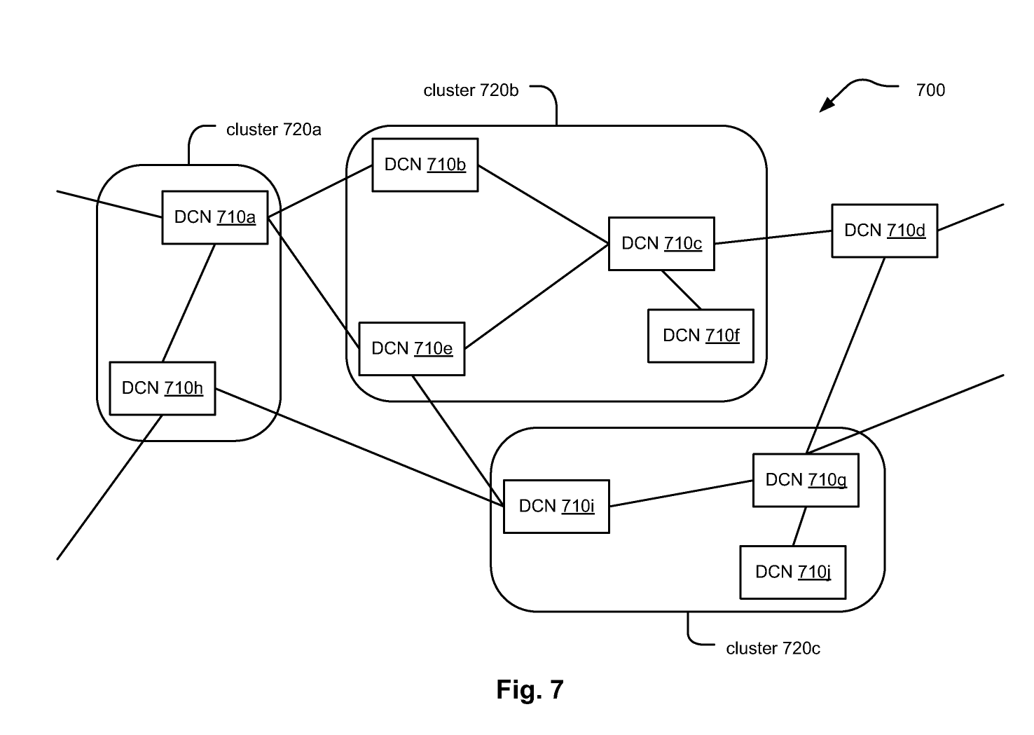

FIG. 7 is a diagram illustrating an embodiment 700 of a number of DCNs partitioned into a number of clusters that perform distributed caching operations therein. This embodiment 700 shows a number of DCNs (shown by reference numerals 710a, 710b, 710c, 710d, 710e, 710f, 710g, 710h, 710i, and 710j). Certain of the DCNs are partitioned together into clusters. For example, the DCNs 710a, 710h are partitioned into a cluster 720a. The DCNs 710a, 710c, 710e, 710f are partitioned into a cluster 720b, and the DCNs 710i, 710g, 710j are partitioned into a cluster 720c. The DCN 710d is not included within any of the clusters 720a, 720b, or 720c.

Distributed caching operations may be effectuated within each of these clusters. For example, in one embodiment, the various DCNs within the cluster 720a perform distributed caching operations amongst themselves but do not involve DCNs implemented outside of the cluster 720a. Similarly, the various DCNs within the cluster 720b perform distributed caching operations amongst themselves but do not involve DCNs implemented outside of the cluster 720b. Analogously, the various DCNs within the cluster 720c perform distributed caching operations amongst themselves but do not involve DCNs implemented outside of the cluster 720c.

As such, each of the clusters 720a, 720b, or 720c may be viewed, from one perspective, to be single entities that perform the caching of content in accordance with overall operation within the communication system.

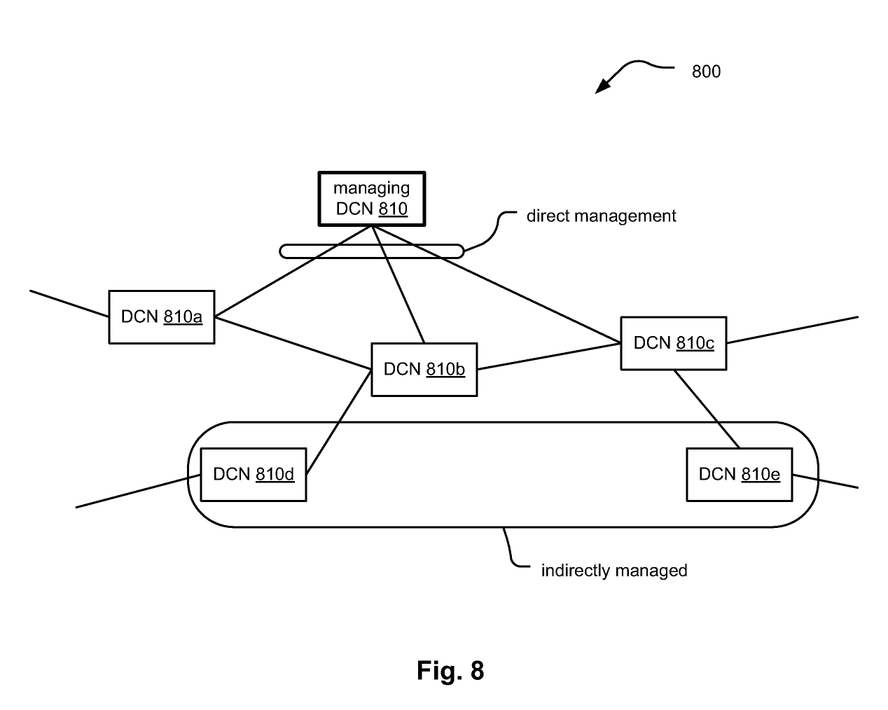

FIG. 8 is a diagram illustrating an embodiment 800 of a number of DCNs whose operation is managed by a managing DCN. This embodiment 800 shows a number of DCNs (shown by reference numerals 810a, 810b, 810c, 810d, and 810e). A managing DCN 810 is directly connected and capable to directly manage certain of the DCNs (shown as DCNs 810a, 810b, and 810c). The managing DCN is operative to communicate with other of the DCNs (e.g., DCNs 810d and 810e) indirectly and to effectuate indirect management thereof.

For example, by employing a managing DCN 810, the distributed caching as performed by the various DCNs within the communication system is managed and controlled by a centralized or managing DCN 810. The managing DCN 810 is operative to direct each of the various DCNs to cache content among the various DCNs.

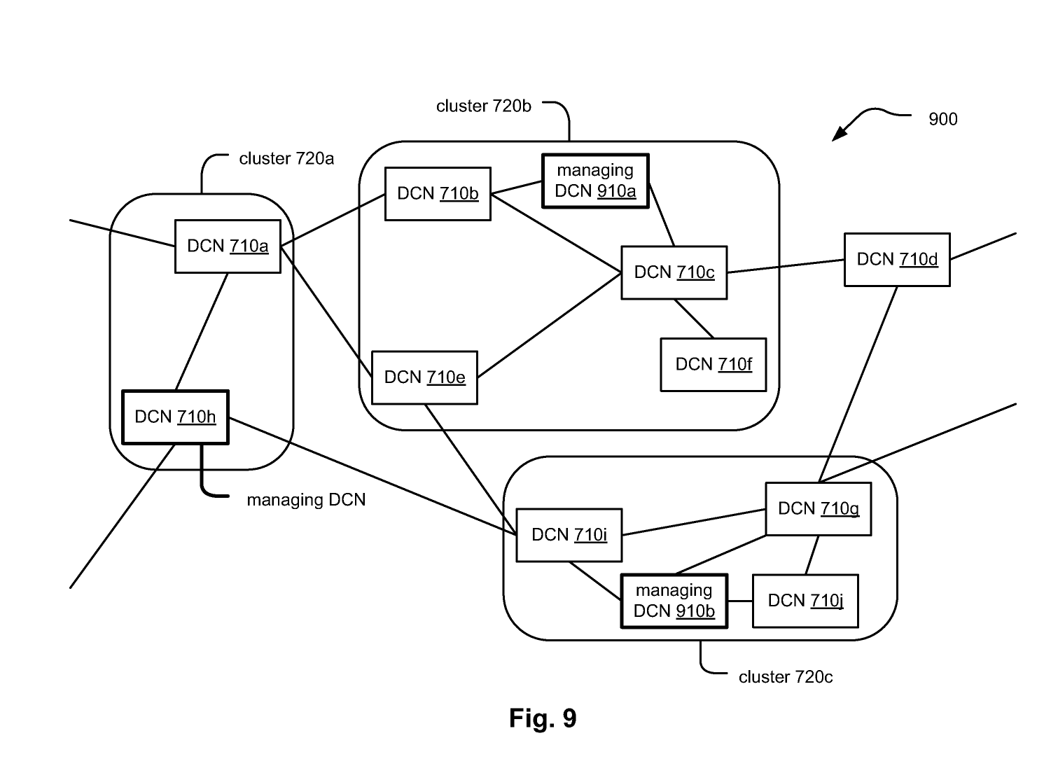

FIG. 9 is a diagram illustrating an embodiment 900 of a number of DCNs, partitioned into a number of clusters, such that the operation of each cluster is managed by a respective, managing DCN. For example, as with the embodiment 700 of FIG. 7, this embodiment 900 shows a number of DCNs (shown by reference numerals 710a, 710b, 710c, 710d, 710e, 710f, 710g, 710h, 710i, and 710j). Certain of the DCNs are partitioned together into clusters. For example, the DCNs 710a, 710h are partitioned into a cluster 720a. The DCNs 710a, 710c, 710e, 710f are partitioned into a cluster 720b, and the DCNs 710i, 710g, 710j are partitioned into a cluster 720c. The DCN 710d is not included within any of the clusters 720a, 720b, or 720c.

However, unlike the embodiment 700 of FIG. 7, the clusters 720a, 720b, or 720c of the embodiment 900 each includes a respective managing DCN. For example, one of the DCNs 720h within the cluster 720a actually operates as a managing DCN. For example, a given DCN may include functionality such that it may at one time it may operate in a cooperative manner with other DCNs in accordance with distributed cache management functionality, while at other times it may operate as a manging DCN to direct the caching operations of other of the DCNs within the communication system (or direct the caching operations of DCNs within a particular cluster within the communication system as shown in this embodiment 900).

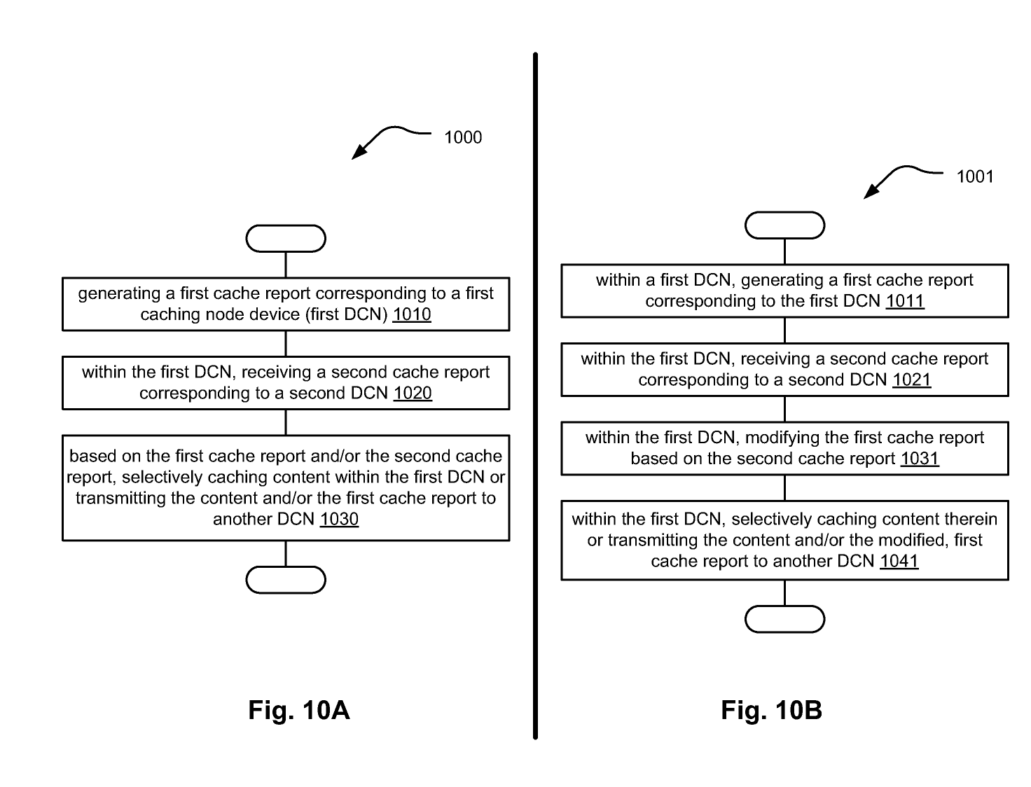

FIG. 10A is a diagram illustrating an embodiment of a method 1000 for performing cache management based on information corresponding to more than one DCN within a communication system.

Referring to method 1000 of FIG. 10A, the method 1000 begins by generating a first cache report corresponding to a first caching node device (e.g., a first DCN), as shown in a block 1010. This first cache report may be generated based on information ascertained or monitored by the first DCN. Alternatively, the first cache report may be generated based on information (not necessarily a cache report) provided to it from one or more other communication devices (such as DCNs) within the communication system.

Within the first DCN, the method 1000 continues by receiving a second cache report corresponding to a second DCN, as shown in a block 1020. This operation shows the first DCN actually receiving a cache report provided to it such that the second cache report corresponds to a second DCN. This second DCN may be provided directly from the second DCN or via an intermediary communication device within the communication system.

Based on the first cache report and/or the second cache report, the method 1000 then operates by selectively caching content within the first DCN or transmitting the content and/or the first cache report to another DCN (e.g., such as the second DCN or to a third DCN within the communication system), as shown in a block 1030.

FIG. 10B is a diagram illustrating an embodiment of an alternative method 1001 for performing cache management based on information corresponding to more than one DCN within a communication system.

Referring to method 1001 of FIG. 10B, within a first DCN, the method 1001 begins by generating a first cache report corresponding to the first DCN as shown in a block 1011. This first cache report may be generated based on information ascertained or monitored by the first DCN. Alternatively, the first cache report may be generated based on information (not necessarily a cache report) provided to it from one or more other communication devices (such as DCNs) within the communication system.

Within the first DCN, the method 1001 then operates by receiving a second cache report corresponding to a second DCN, as shown in a block 1021. This operation shows the first DCN actually receiving a cache report provided to it such that the second cache report corresponds to a second DCN. This second DCN may be provided directly from the second DCN or via an intermediary communication device within the communication system.

Within the first DCN, the method 1001 continues by modifying the first cache report based on the second cache report, as shown in a block 1031. Within the first DCN, the method 1001 then operates by selectively caching content therein or transmitting the content and/or the modified, first cache report to another DCN (e.g., such as the second DCN or to a third DCN within the communication system), as shown in a block 1041.

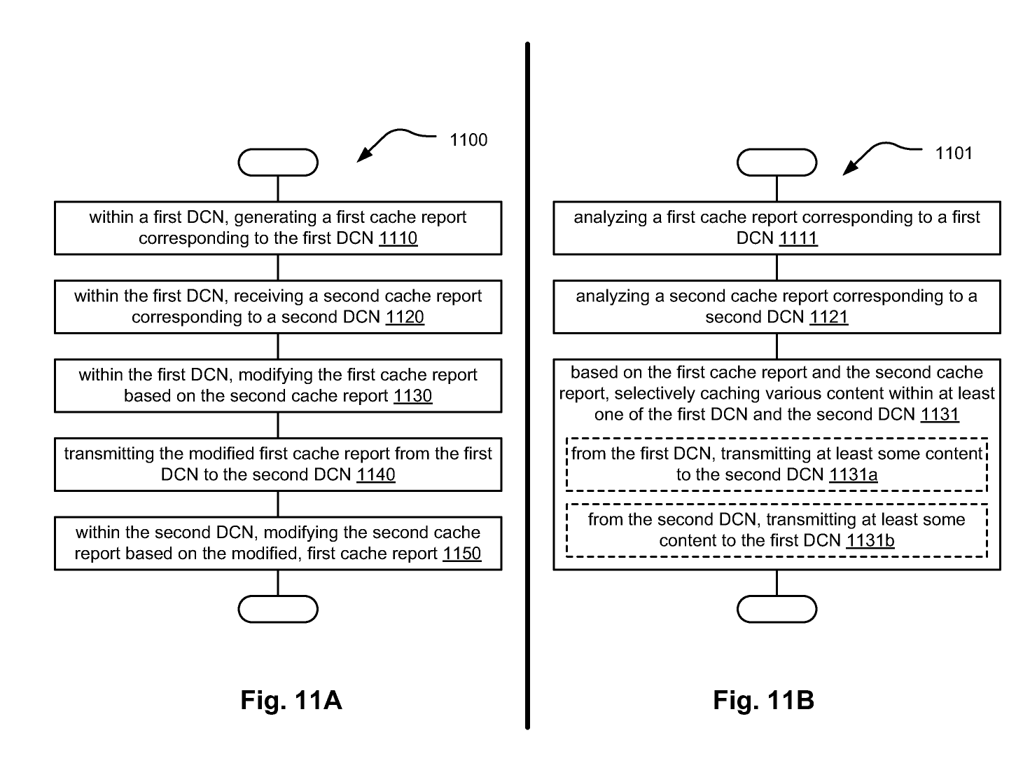

FIG. 11A is a diagram illustrating an embodiment of a method 1100 for performing cache management across multiple DCNs within a communication system.

Referring to method 1100 of FIG. 11A, within a first DCN, the method 1100 begins by generating a first cache report corresponding to the first DCN as shown in a block 1110. Within the first DCN, the method 1100 continues by receiving a second cache report corresponding to a second DCN, as shown in a block 1120.

Within the first DCN, the method 1100 then operates by modifying the first cache report based on the second cache report, as shown in a block 1130. The method 1100 continues by transmitting the modified first cache report from the first DCN to the second DCN, as shown in a block 1140.

Within the second DCN, the method 1100 continues by modifying the second cache report based on the modified, first cache report, as shown in a block 1150.

FIG. 11B is a diagram illustrating an embodiment of a method 1101 for performing selective content caching across multiple DCNs within a communication system.

Referring to method 1101 of FIG. 11B, the method 1101 begins by analyzing a first cache report corresponding to a first DCN, as shown in a block 1111. The method 1101 then operates by analyzing a second cache report corresponding to a second DCN, as shown in a block 1121.

Based on the first cache report and the second cache report, the method 1101 continues by selectively caching various content within at least one of the first DCN and the second DCN, as shown in a block 1131.

In some embodiments, the step performed in the block 1131 may also involve operating by transmitting at least some content to the second DCN from the first DCN, as shown in a block 1131a. In such or other embodiments, the step performed in the block 1131 may also or alternatively involve operating by transmitting at least some content to the first DCN from the second DCN, as shown in a block 1131b.

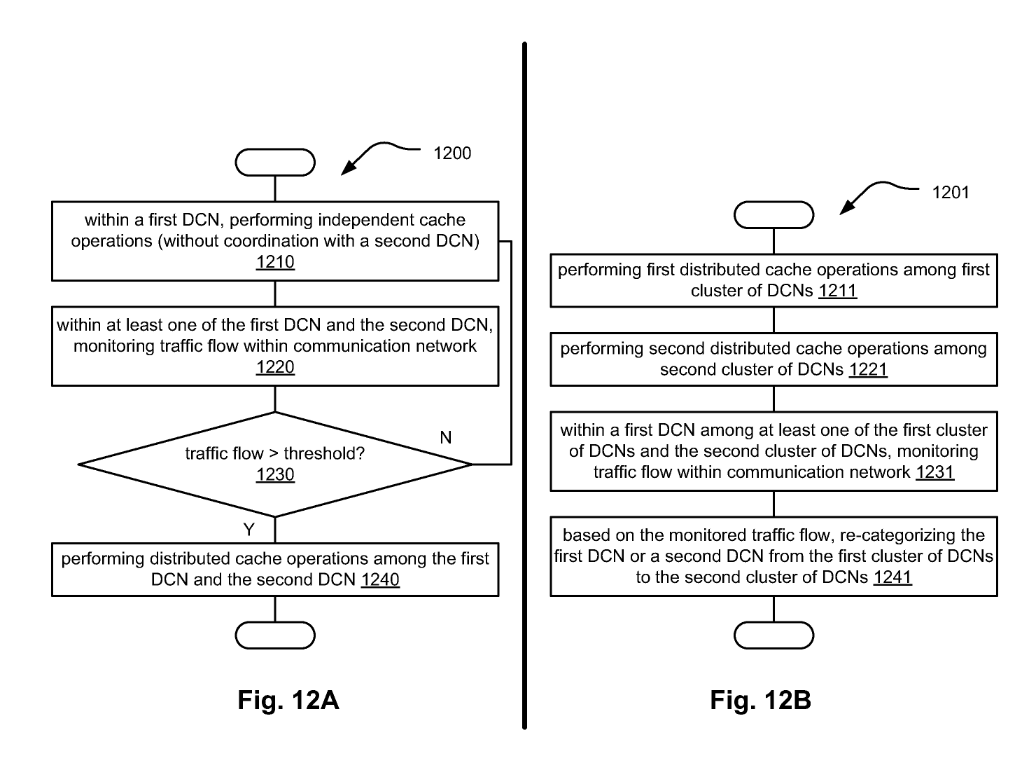

FIG. 12A is a diagram illustrating an embodiment of a method 1200 for selectively performing independent and distributed caching operations.

Referring to method 1200 of FIG. 12A, the method 1200 begins by performing independent cache operations (without coordination with a second DCN) within a first DCN, as shown in a block 1210. Within at least one of the first DCN and the second DCN, the method 1200 continues by monitoring traffic flow within communication network, as shown in a block 1220.

The method 1200 then operates by comparing the monitored traffic flow to a threshold, as shown in a decision block 1230. As mentioned with other embodiments, the threshold may be a fixed/predetermined threshold or it may be adaptively determined (or adaptively adjusted) based on any of a number of parameters, conditions, etc.

If the traffic flow does exceed the threshold as determined in the decision block 1230, then method 1200 continues by performing distributed cache operations among the first DCN and the second DCN, as shown in a block 1240.

Alternatively, if the traffic flow does not exceed the threshold as determined in the decision block 1230, then method 1200 continues by performing the operations as shown in the block 1210.

FIG. 12B is a diagram illustrating an embodiment of a method 1201 for operating a number of DCNs, partitioned into a number of clusters, to perform caching operations therein.

Referring to method 1201 of FIG. 12B, the method 1201 begins by performing first distributed cache operations among first cluster of DCNs, as shown in a block 1211. The method 1201 then operates by performing second distributed cache operations among second cluster of DCNs, as shown in a block 1221.

Within a first DCN among at least one of the first cluster of DCNs and the second cluster of DCNs, the method 1201 continues by monitoring traffic flow within communication network, as shown in a block 1231. Then, based on the monitored traffic flow, the method 1201 then operates by re-categorizing the first DCN or a second DCN from the first cluster of DCNs to the second cluster of DCNs, as shown in a block 1241.

It is noted that the various modules (e.g., DCNs, management circuitries, cache circuitries, processing circuitries, etc.) described herein may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The operational instructions may be stored in a memory. The memory may be a single memory device or a plurality of memory devices. Such a memory device may be a read-only memory, random access memory, volatile memory, non-volatile memory, static memory, dynamic memory, flash memory, and/or any device that stores digital information. It is also noted that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. In such an embodiment, a memory stores, and a processing module coupled thereto executes, operational instructions corresponding to at least some of the steps and/or functions illustrated and/or described herein.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. An apparatus, comprising:
a first caching node device that is operative to generate a first cache report corresponding to the first caching node device;
a second caching node device, operative to communicate with the first caching node device, that is operative to generate a second cache report corresponding to the second caching node device; and wherein:
the first caching node device is operative to:
receive the second cache report corresponding to the second caching node device; and
based on the second cache report, selectively cache first content within the first caching node device or transmit the first content to the second caching node device or to a third caching node device;
the second caching node device is operative to:
receive the first cache report corresponding to the first caching node device; and
based on the first cache report, selectively cache second content within the second caching node device or transmit the second content to the first caching node device or to a fourth caching node device.

2. The apparatus of claim 1, wherein, at least one:
the first cache report indicates cache storing capability of the first caching node device; and
the second cache report indicates cache storing capability of the second caching node device.

3. The apparatus of claim 1, wherein, at least one:
the first cache report indicates cache history corresponding to the first content or a first least one additional content that has been stored within the first caching node device or communicated via the first caching node device; and
the second cache report indicates cache history corresponding to the second content or a second least one additional content that has been stored within the second caching node device or communicated via the second caching node device.

4. The apparatus of claim 1, wherein, at least one:
the first cache report indicates identification of at least one additional caching node device that provides a plurality of requests to the first caching node device for the first content.

5. The apparatus of claim 1, wherein, at least one:
the second cache report indicates identification of at least one additional caching node device that provides a plurality of requests to the second caching node device for the second content.

6. The apparatus of claim 1, wherein:
when the first caching node device selectively caches the first content within the first caching node device, the first caching node device is operative to transmit the first cache report to at least one additional caching node device.

7. The apparatus of claim 1, wherein:
when the second caching node device selectively caches the second content within the second caching node device, the second caching node device is operative to transmit the second cache report to at least one additional caching node device.

8. The apparatus of claim 1, wherein:
the first caching node device and the second caching node device operate cooperatively to cache a plurality of content, the plurality of content includes the first content and the second content, among the first caching node device and the second caching node device.

9. The apparatus of claim 1, further comprising a managing caching node device that is operative to:
communicate with the first caching node device, the second caching node device, the third caching node device, and the fourth caching node device; and
direct each of the first caching node device, the second caching node device, the third caching node device, and the fourth caching node device to cache a plurality of content, the plurality of content includes the first content and the second content, among the first caching node device, the second caching node device, the third caching node device, and the fourth caching node device.

10. An apparatus, comprising:
a first caching node device that is operative to:
generate a first cache report corresponding to the first caching node device;
receive a second cache report corresponding to a second caching node device; and
based on the second cache report, selectively cache content within the first caching node device or transmit the content and the first cache report to the second caching node device or to a third caching node device.

11. The apparatus of claim 10, wherein, at least one:
the first cache report indicates cache storing capability of the first caching node device; and
the second cache report indicates cache storing capability of the second caching node device.

12. The apparatus of claim 10, wherein, at least one:
the first cache report indicates cache history corresponding to the content or at least one additional content that has been stored within the first caching node device or communicated via the first caching node device; and
the second cache report indicates cache history corresponding to the content or at least one additional content that has been stored within the second caching node device or communicated via the second caching node device.

13. The apparatus of claim 10, wherein, at least one:
the first cache report indicates identification of at least one additional caching node device that provides a plurality of requests to the first caching node device for the content.

14. The apparatus of claim 10, wherein:
when the first caching node device selectively caches content within the first caching node device, the first caching node device is operative to transmit the first cache report to at least one additional caching node device.

15. The apparatus of claim 10, wherein the first caching node device is operative to:
receive a third cache report corresponding to a fourth caching node device; and
based on the second cache report and the third cache report, selectively cache the content within the first caching node device or transmit the content and the first cache report to at least one additional caching node device.

16. The apparatus of claim 10, wherein:
the second caching node device or the third caching node device is operative to cache the content received from the first caching node device.

17. The apparatus of claim 10, wherein:
the first caching node device and the second caching node device or the third caching node device operate cooperatively to cache a plurality of content there among, the plurality of content includes the content.

18. The apparatus of claim 10, further comprising a managing caching node device that is operative to:
communicate with the first caching node device, the second caching node device, and the third caching node device; and
direct each of the first caching node device, the second caching node device, and the third caching node device to cache a plurality of content, the plurality of content includes the content, among the first caching node device, the second caching node device, and the third caching node device.

19. A method, comprising:
generating a first cache report corresponding to a first caching node device;
within the first caching node device, receiving a second cache report corresponding to a second caching node device; and
based on the second cache report, selectively caching content within the first caching node device or transmitting the content and the first cache report to the second caching node device or to a third caching node device.

20. The method of claim 19, wherein, at least one:
the first cache report indicates cache storing capability of the first caching node device; and
the second cache report indicates cache storing capability of the second caching node device.

21. The method of claim 19, wherein, at least one:
the first cache report indicates cache history corresponding to the content or at least one additional content that has been stored within the first caching node device or communicated via the first caching node device; and
the second cache report indicates cache history corresponding to the content or at least one additional content that has been stored within the second caching node device or communicated via the second caching node device.

22. The method of claim 19, wherein, at least one:
the first cache report indicates identification of at least one additional caching node device that provides a plurality of requests to the first caching node device for the content.

23. The method of claim 19, further comprising:
when selectively caching content within the first caching node device, transmitting the first cache report from the first caching node device to at least one additional caching node device.

24. The method of claim 19, within the first caching node device, further comprising:
receiving a third cache report corresponding to a fourth caching node device; and
based on the second cache report and the third cache report, selectively caching the content within the first caching node device or transmitting the content and the first cache report to at least one additional caching node device.

25. The method of claim 19, wherein:
the second caching node device or the third caching node device is operative to cache the content received from the first caching node device.

26. The method of claim 19, wherein:
the first caching node device and the second caching node device or the third caching node device operate cooperatively to cache a plurality of content there among, the plurality of content includes the content.

27. The method of claim 19, further comprising employing a managing caching node device to perform:
communicating with the first caching node device, the second caching node device, and the third caching node device; and
directing each of the first caching node device, the second caching node device, and the third caching node device to cache a plurality of content, the plurality of content includes the content, among the first caching node device, the second caching node device, and the third caching node device.
